(19) United States
(12) Patent Application Publication
(10) Pub. No.: US 2020/0387436 A1
(43) Pub. Date: Dec. 10, 2020

(54) FAILURE DETECTION SYSTEM AND NON-TRANSITORY COMPUTER-READABLE RECORDING MEDIUM STORING FAILURE DETECTION PROGRAM

(71) Applicant: KYOCERA Document Solutions Inc., Osaka (JP)

(72) Inventors: Kazuki NISHIKAI, Osaka (JP); Yuichi OBAYASHI, Osaka (JP); Satoshi GOSHIMA, Osaka (JP); Yasuo NAKASHIMA, Osaka (JP); Koki NAKAJIMA, Osaka (JP); Takeshi NAKAMURA, Osaka (JP); Dukil PARK, Osaka (JP)

(21) Appl. No.: 16/893,718

(22) Filed: Jun. 5, 2020

(30) Foreign Application Priority Data
Jun. 7, 2019 (JP) 2019-107001

(51) Int. Cl. G06F 11/273; G06F 11/00

(52) U.S. Cl. CPC G06F 11/2733; G06F 11/008

(57) ABSTRACT

A failure detection system detects a failure in a remote management system that performs remote management of image forming apparatuses. The failure detection system automatically executes a UI test that is a test for normality of the remote management system with respect to an operation through a web application serving as a user interface of the remote management system, and reports a failure in the remote management system depending on the result of the executed UI test.

### INCORPORATION BY REFERENCE

This application is based upon, and claims the benefit of priority from, corresponding Japanese Patent Application No. 2019-107001 filed in the Japan Patent Office on Jun. 7, 2019, the entire contents of which are incorporated herein by reference.

### BACKGROUND

### Field of the Invention

The present disclosure relates to a failure detection system that detects failures in a system and a non-transitory computer-readable recording medium storing a failure detection program.

### Description of Related Art

The detection of a failure in a server based on the increase in the central processing unit (CPU) usage of the server has been known. However, in conventional techniques, since a failure in a server cannot be detected with respect to operations through a user interface (UI) of the server, a failure in the server is noticed only by an indication from a user.

### SUMMARY

A failure detection system according to the present disclosure detects a failure in a system. The failure detection system includes a test executor that automatically executes a test for normality of the system with respect to an operation through a user interface of the system, and a failure reporter that reports the failure according to a result of the test executed by the test executor.

In the failure detection system of the present disclosure, the test may be executed to detect an abnormality in output content in the test.

In the failure detection system of the present disclosure, the test may also be executed to detect an abnormality in time having been occupied by the test.

A non-transitory computer-readable recording medium according to the present disclosure stores a failure detection program for detecting a failure in a system. The failure detection program causes a computer to implement a test executor to automatically execute a test for normality of the system with respect to an operation through a user interface of the system, and a failure reporter to report the failure according to a result of the test executed by the test executor.

### BRIEF DESCRIPTION OF THE DRAWINGS

FIG. 1 is a block diagram of a system according to an embodiment of the present disclosure;

FIG. 2 is a block diagram of a remote management system shown in FIG. 1, which is constructed of one computer in the illustrated example;

FIG. 3 is a block diagram of a monitoring system shown in FIG. 1, which is constructed of one computer in the illustrated example;

FIG. 4 is a block diagram of a UI test system shown in FIG. 1, which is constructed of one computer in the illustrated example;

FIG. 5 is a diagram showing an example of a test scenario table shown in FIG. 4;

FIG. 6 is a diagram showing an example of a test case table shown in FIG. 4;

FIG. 7 is a diagram showing an example of a parameter table shown in FIG. 4;

FIG. 8 is a diagram showing an example of a test result database shown in FIG. 4;

FIG. 9 is a flowchart showing operations, which the UI test system shown in FIG. 4 takes when executing a UI test;

FIG. 10 is a flowchart showing operations, which the UI test system shown in FIG. 4 takes when determining whether to send a message to a monitoring system; and

FIG. 11 is a flowchart showing operations, which the monitoring system shown in FIG. 3 takes when having received a message from a UI test system.

### DETAILED DESCRIPTION

Below, an embodiment of the present disclosure will be described using the drawings.

First, the structure of a system according to an embodiment of the present disclosure will be described.

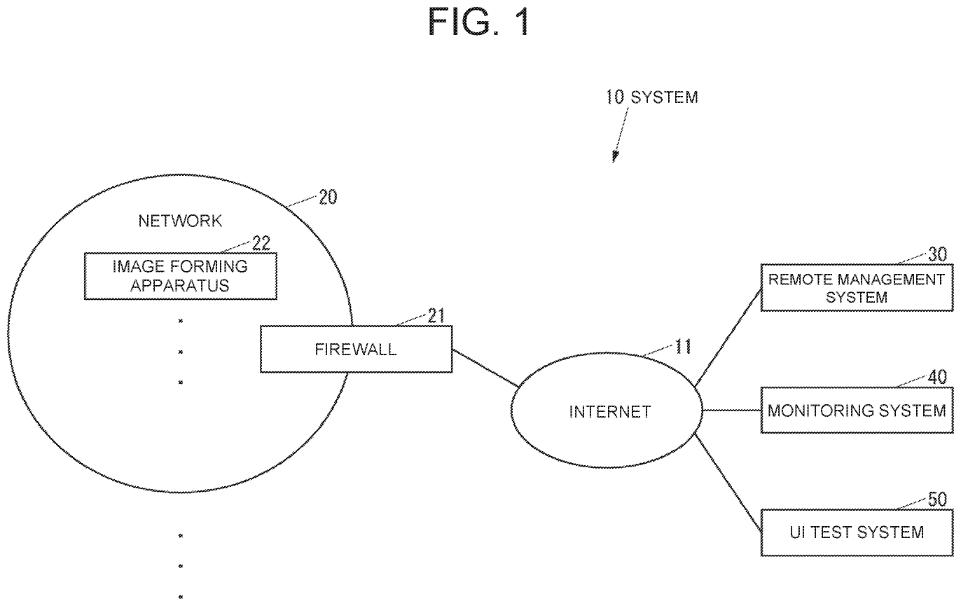

FIG. 1 is a block diagram of a system according to an embodiment of the present disclosure.

As shown in FIG. 1, a system 10 includes a network 20 such as a local area network (LAN) of a customer of a company (hereinafter referred to as “management company”) that manages image forming apparatuses. Aside from the network 20, the system 10 may also include at least one network with the same structure as the network 20.

The network 20 includes a firewall 21 that controls the communications between the inside of the network 20 and the outside of the network 20, and an image forming apparatus 22. Aside from the image forming apparatus 22, the network 20 may additionally include at least one image forming apparatus having the same structure as the image forming apparatus 22. In the network 20, image forming apparatuses are each a multifunction peripheral (MFP) or a dedicated printer, for instance, and are used by customers of the management company.

The system 10 includes a remote management system 30 that performs remote management of respective image forming apparatuses in the system 10. The remote management system 30 can manage an enormous number, such as several millions, of image forming apparatuses distributed around the world. The remote management system 30 is used by the management company. The remote management system 30 may include one computer, or multiple computers. In the following, the remote management system 30 is assumed to operate on a cloud platform of a public cloud.

Since the remote management system 30 can have many connections with image forming apparatuses over the Internet 11, the capacity of a server constituting the remote management system 30 is expanded responsively along with the increase in number of image forming apparatuses connected with the remote management system 30. Further, the cloud platform, on which the remote management system 30 operates, may be subject to system failure or maintenance and, accordingly, part of the system may go down at times unknown to the remote management system 30.

The system 10 includes a monitoring system 40 that monitors the remote management system 30. The monitoring system 40 is used by the management company. The monitoring system 40 may include one computer, or multiple computers.

The system 10 includes a user interface (UI) test system 50 as a failure detection system that executes a test for the normality of the response of the remote management system 30 to an operation through a UI of the remote management system 30 (the test being hereinafter referred to as “UI test”). The UI test system 50 is used by the management company. The UI test system 50 may include one computer, or multiple computers.

The computer constituting the monitoring system 40 and the computer constituting the UI test system 50 may have at least one part in common.

In the system 10, respective networks, the remote management system 30, the monitoring system 40, and the UI test system 50 are capable of communicating with each other over the Internet 11.

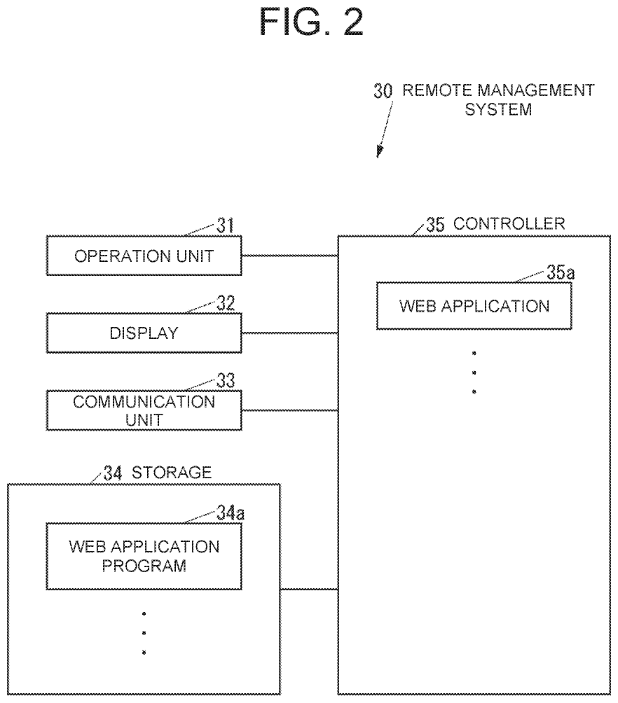

FIG. 2 is a block diagram of the remote management system 30, which is constructed of one computer in the illustrated example.

The remote management system 30 shown in FIG. 2 includes an operation unit 31 that is an operation device such as a keyboard or a mouse, through which various operations are input. The remote management system 30 also includes a display 32, which is a displaying device such as a liquid crystal display (LCD) that displays various types of information. The remote management system 30 also includes a communication unit 33, which is a communication device that communicates with external devices over a network, such as a LAN or the Internet 11, or with no networks but through a direct wired or wireless connection. The remote management system 30 also includes a storage 34, which is a non-volatile storage device such as a semiconductor memory or a hard disk drive (HDD) that stores various types of information, and a controller 35 which controls the remote management system 30 as a whole.

The storage 34 stores a web application program 34a for allowing a user to operate the remote management system 30. The storage 34 can store at least one web application program similar to the web application program 34a. The web application program may be installed in the remote management system 30 during the manufacture of the remote management system 30, or may additionally be installed in the remote management system 30 from an external recording medium such as a compact disc (CD), a digital versatile disc (DVD) or a universal serial bus (USB) memory, or may additionally be installed in the remote management system 30 over a network.

The controller 35 includes, for example, a central processing unit (CPU), a read only memory (ROM) storing programs and various data, and a random access memory (RAM) which is a memory used as a workspace for the CPU of the controller 35. The CPU of the controller 35 executes programs stored in the storage 34 or in the ROM of the controller 35.

The controller 35 executes the web application program 34a to cause a web application 35a for allowing a user to operate the remote management system 30 to serve as a UI. Similarly in terms of a web application program other than the web application program 34a, the controller 35 executes the web application program to cause a web application for allowing a user to operate the remote management system 30 to serve as a UI. For access, each web application of the remote management system 30 is provided with a unique uniform resource locator (URL). A user of the remote management system 30 can operate the remote management system 30 through a web browser on a computer (not shown) and a web application of the remote management system 30 by accessing the web application from the web browser over the internet 11.

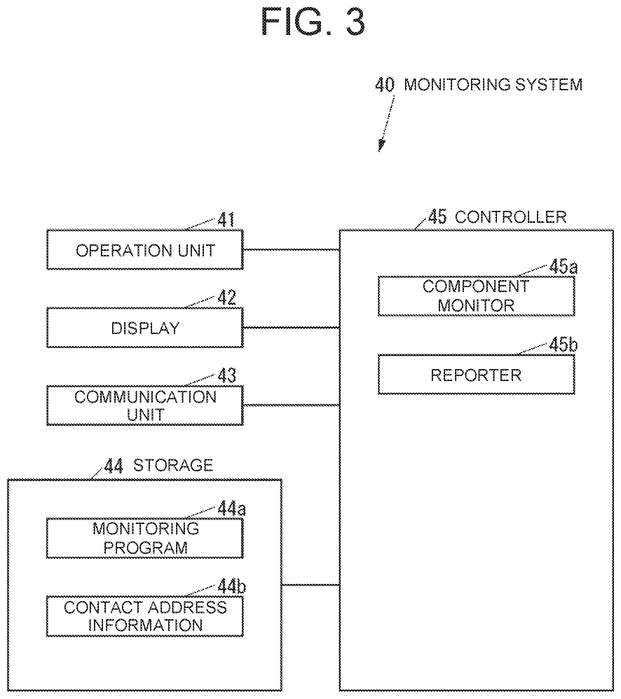

FIG. 3 is a block diagram of the monitoring system 40, which is constructed of one computer in the illustrated example.

The monitoring system 40 shown in FIG. 3 includes an operation unit 41 that is an operation device such as a keyboard or a mouse, through which various operations are input. The monitoring system 40 also includes a display 42, which is a displaying device such as an LCD that displays various types of information. The monitoring system 40 also includes a communication unit 43, which is a communication device that communicates with external devices over a network, such as a LAN or the Internet 11, or with no networks but through a direct wired or wireless connection. The monitoring system 40 also includes a storage 44, which is a non-volatile storage device such as a semiconductor memory or an HDD that stores various types of information, and a controller 45 which controls the monitoring system 40 as a whole.

The storage 44 stores a monitoring program 44a for monitoring the remote management system 30 (see FIG. 2). The monitoring program 44a may be installed in the monitoring system 40 during the manufacture of the monitoring system 40, or may additionally be installed in the monitoring system 40 from an external recording medium such as a CD, a DVD or a USB memory, or may additionally be installed in the monitoring system 40 over a network.

The storage 44 stores contact address information 44b, which contains a contact address for various types of information. The contact address to be contained in the contact address information 44b is, for example, an electronic mail (e-mail) address. The contact address information 44b may contain multiple contact addresses, such as the contact address of the developer of the remote management system 30 and the contact address of a user of the remote management system 30.

The controller 45 includes, for example, a CPU, a ROM storing programs and various data, and a RAM which is a memory used as a workspace for the CPU of the controller 45. The CPU of the controller 45 executes programs stored in the storage 44 or in the ROM of the controller 45.

The controller 45 executes the monitoring program 44a to implement a component monitor 45a that monitors, for instance, the load on each component of the remote management system 30, and a reporter 45b that sends a report to the contact address contained in the contact address information 44b when the result of monitoring by the component monitor 45a fulfills a preset condition.

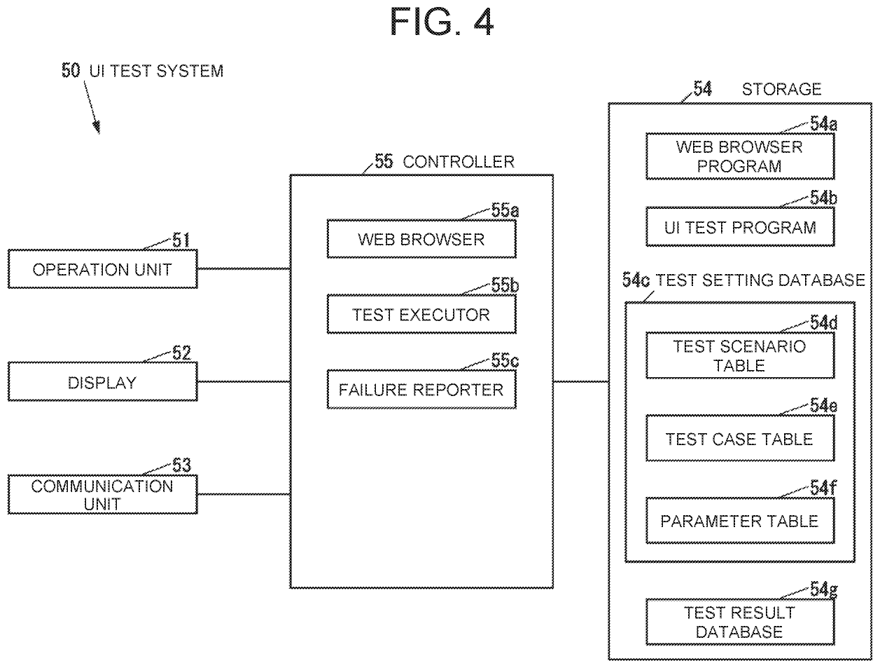

FIG. 4 is a block diagram of the UI test system 50, which is constructed of one computer in the illustrated example.

The UI test system 50 shown in FIG. 4 includes an operation unit 51 that is an operation device such as a keyboard or a mouse, through which various operations are input. The UI test system 50 also includes a display 52, which is a displaying device such as an LCD that displays various types of information. The UI test system 50 also includes a communication unit 53, which is a communication device that communicates with external devices over a network, such as a LAN or the Internet 11, or with no networks but through a direct wired or wireless connection. The UI test system 50 also includes a storage 54, which is a non-volatile storage device such as a semiconductor memory or an HDD that stores various types of information, and a controller 55 which controls the UI test system 50 as a whole.

The storage 54 stores a web browser program 54a for accessing web pages and a UI test program 54b as a failure detection program for executing UI tests. The web browser program 54a and the UI test program 54b may each be installed in the UI test system 50 during the manufacture of the UI test system 50, or may each additionally be installed in the UI test system 50 from an external recording medium such as a CD, a DVD or a USB memory, or may each additionally be installed in the UI test system 50 over a network.

The storage 54 stores a test setting database 54c which includes various settings for the UI tests. The test setting database 54c includes a test scenario table 54d which shows scenarios for UI tests, a test case table 54e which shows test cases each constituting at least part of a scenario, and a parameter table 54f which shows parameters utilized in the UI tests. To each scenario shown in the test scenario table 54d, an identification (ID) (hereinafter referred to as “scenario ID”) is attached to differentiate the scenarios from each other. To each test case shown in the test case table 54e, an ID (hereinafter referred to as “test case ID”) is attached to differentiate the test cases from each other. To each group of parameters shown in the parameter table 54f, an ID (hereinafter referred to as “parameter ID”) is attached to differentiate the groups of parameters from each other. The various data in the test setting database 54c can be set through the operation unit 51 or the communication unit 53.

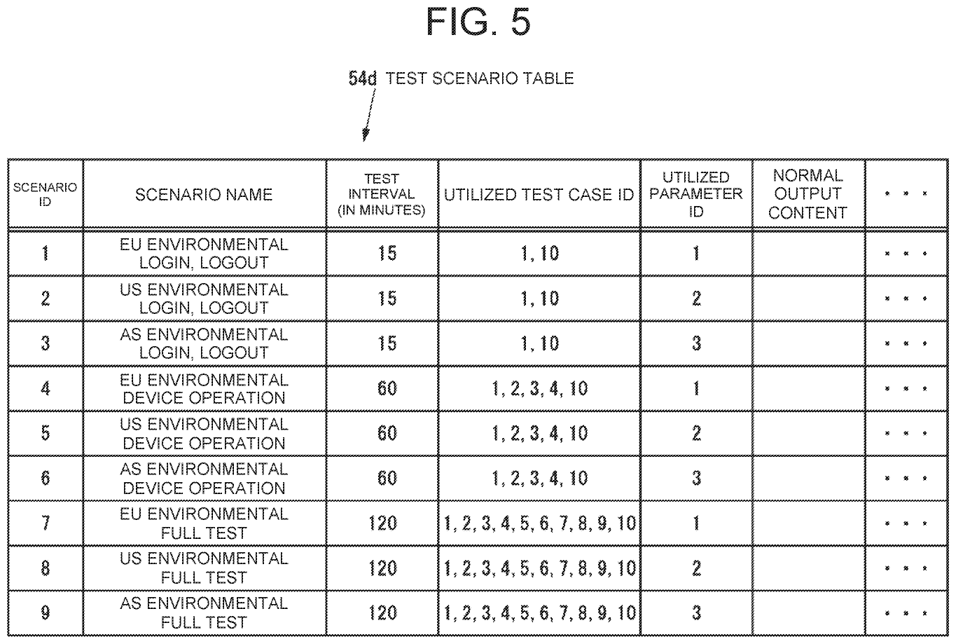

FIG. 5 is a diagram showing an example of the test scenario table 54d.

As shown in FIG. 5, the test scenario table 54d includes data for each scenario. The data of each scenario includes the scenario ID, the scenario name, which is the title of the relevant scenario, the test interval (in minutes), which indicates, in units of minutes, an interval for automatically repeating the relevant scenario, the utilized test case ID, which indicates the test case ID of the test case to be utilized, the utilized parameter ID, which indicates the parameter ID of the parameter to be utilized, and the normal output content, which indicates a normal output content in the UI test according to the relevant scenario, all in association with each other. In FIG. 5, specific values of the normal output content are omitted.

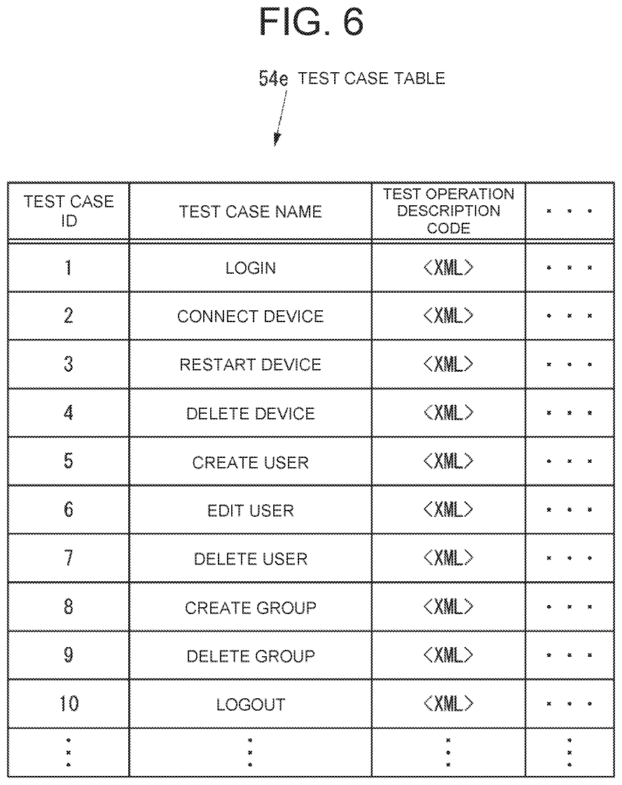

FIG. 6 is a diagram showing an example of the test case table 54e.

As shown in FIG. 6, the test case table 54e includes data for each test case. The data of each test case includes the test case ID, the test case name, which is the title of the relevant test case, and the test operation description code, which indicates specific operations for a web browser 55a (described later) in the relevant test case that are described in extensible markup language (XML) or other language used for the web browser 55a, all in association with each other.

In FIG. 6, specific contents of the test operation description code are omitted. As an example, the operations, which are indicated by the test operation description code of the test case with the test case name “login,” are as follows.

1. Open the web page screen at the URL of the web application of the remote management system 30.

2. On the screen opened in the above operation 1, click the input frame for the ID of the user (hereinafter referred to as “user ID”) to make the input frame input-enabling.

3. Type the user ID in the input frame that was made input-enabling in the above operation 2.

4. On the screen opened in the above operation 1, click the input frame for the password to make the input frame input-enabling.

5. Type the password in the input frame that was made input-enabling in the above operation 4.

6. On the screen opened in the above operation 1, click the login button.

7. On the screen opened because of the click in the above operation 6, in other words, on the screen after login, check that a correct user ID is displayed in a correct position.

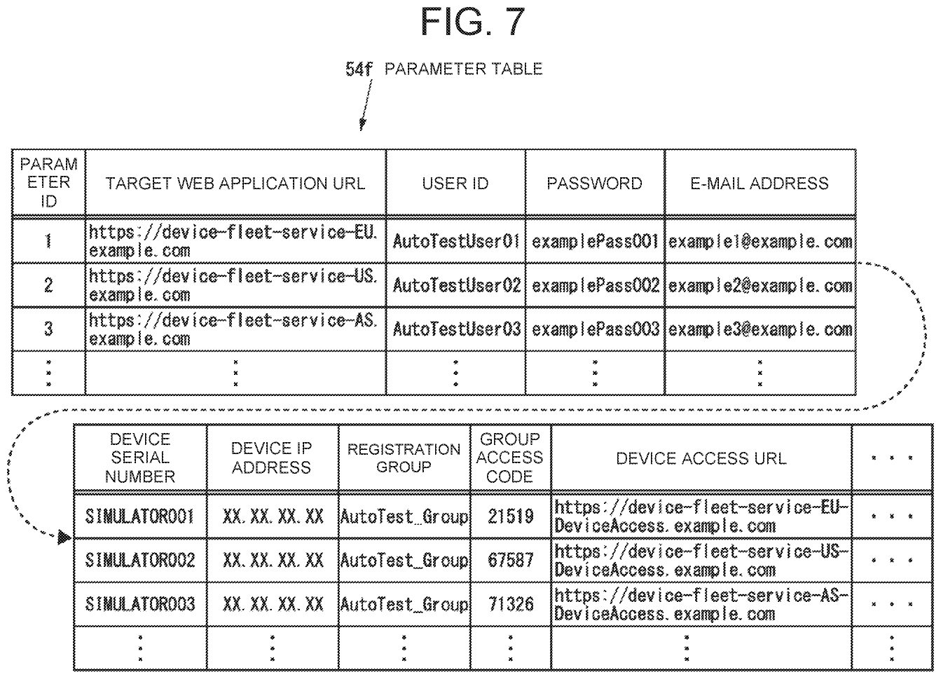

FIG. 7 is a diagram showing an example of the parameter table 54f.

As shown in FIG. 7, the parameter table 54f includes data for each parameter group. The data of each parameter group includes the parameter ID, the target web application URL, indicating the URL of a web application that is the target of the UI test, the user ID, the password for the user, the e-mail address of the user, the device serial number, which is the serial number of the target image forming apparatus, the device internet protocol (IP) address, which is the IP address of the target image forming apparatus, the registration group, indicating the group in which the target image forming apparatus is to be registered, the group access code, indicating the code for accessing a registration group, and the device access URL, indicating the URL for accessing the target image forming apparatus, all in association with each other. The target web application URL, the user ID, the password, the e-mail address, the device serial number, the device IP address, the registration group, the group access code, and the device access URL are all parameters utilized in the UI test.

The target web application URL, the user ID, and the password are utilized, for example, in the test case with the test case name “login”. The e-mail address is utilized, for example, in the test case with the test case name “create user”. The device serial number is utilized, for example, in the test case with the test case name “restart device”. The device IP address, the group access code, and the device access URL are utilized, for example, in the test case with the test case name “connect device”. The registration group is utilized, for example, in the test case with the test case name “create group”.

As shown in FIG. 4, the storage 54 stores a test result database 54g that includes the results of UI tests (hereinafter referred to as “test results”). To each test result included in the test result database 54g, an ID (hereinafter referred to as “test result ID”) is attached to differentiate the test results from each other.

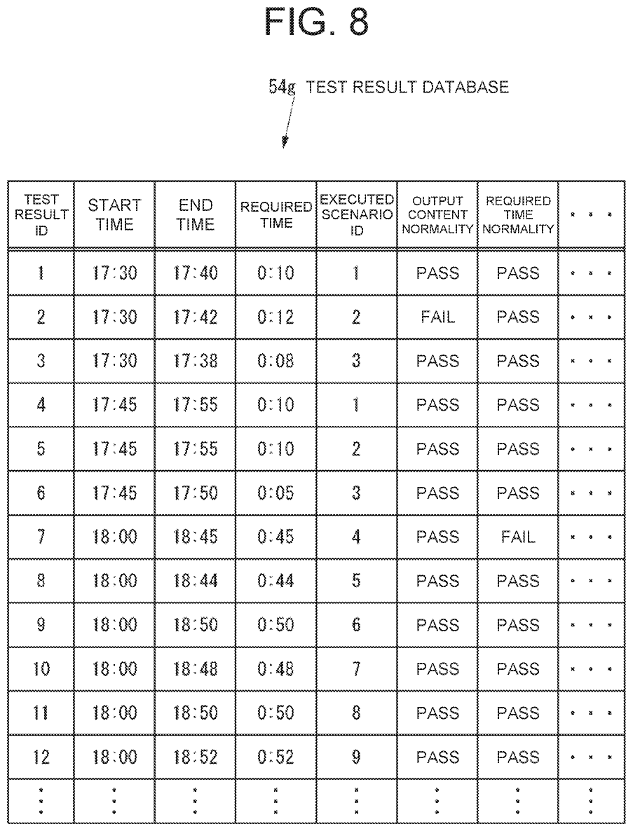

FIG. 8 is a diagram showing an example of the test result database 54g.

As shown in FIG. 8, the test result database 54g includes data for each test result. The data of each test result includes the test result ID, the start time when the UI test started, the end time when the UI test ended, the required time as time having been occupied by the UI test, the executed scenario ID, which indicates the scenario ID of the scenario executed in the UI test, the output content normality, which indicates the normality of the output content in the UI test, and the required time normality, which indicates the normality of the required time of the UI test, all in association with each other. The required time is the time from the start time to the end time.

As shown in FIG. 4, the controller 55 includes, for example, a CPU, a ROM storing programs and various data, and a RAM which is used as a workspace for the CPU of the controller 55. The CPU of the controller 55 executes programs stored in the storage 54 or in the ROM of the controller 55.

The controller 55 executes the web browser program 54a to implement the web browser 55a for accessing web pages.

The controller 55 executes the UI test program 54b to implement a test executor 55b that automatically executes a UI test, and a failure reporter 55c that reports a failure in the remote management system 30 depending on the test result.

Next, the operation of the system 10 will be described.

First, description is made on the operations, which the UI test system 50 takes when executing a UI test.

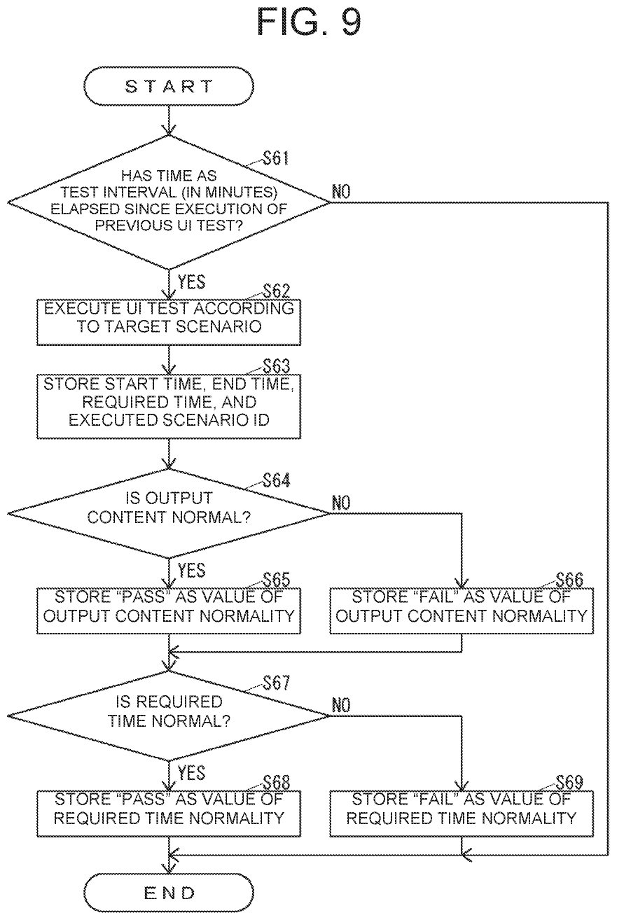

FIG. 9 is a flowchart of the operations, which the UI test system 50 takes when executing a UI test.

The controller 55 of the UI test system 50 executes the operations shown in FIG. 9 periodically, for example, every minute for each scenario in the test scenario table 54d.

As shown in FIG. 9, the test executor 55b of the UI test system 50 determines, for the target scenario, whether the time indicated by the test interval (in minutes) in the test scenario table 54d has passed by from the time of execution of the previous UI test, based on the data included in the test result database 54g (S61). The test executor 55b may use the start time of the previous UI test or the end time of the previous UI test as the time of execution of the previous UI test.

When determining in S61 for the target scenario that the time indicated by the test interval (in minutes) in the test scenario table 54d has not passed by from the time of execution of the previous UI test, the test executor 55b ends the operations shown in FIG. 9.

When determining in S61 for the target scenario that the time indicated by the test interval (in minutes) in the test scenario table 54d has passed by from the time of execution of the previous UI test, the test executor 55b then executes the UI test according to the target scenario using the test scenario table 54d, the test case table 54e, and the parameter table 54f (S62). In other words, the test executor 55b accesses the web application of the remote management system 30 over the internet 11 through the web browser 55a, and operates the remote management system 30 through the web application and the web browser 55a as detailed in the target scenario.

After the processing of S62, the test executor 55b stores the start time, the end time, the required time, and the executed scenario ID from the UI test executed in S62 (hereinafter referred to as “current UI test”) in the test result database 54g (S63). The test executor 55b assigns a test result ID to the result of the current UI test.

After the processing of S63, the test executor 55b determines whether the output content in the current UI test is normal based on the normal output content in the test scenario table 54d (S64).

When determining in S64 that the output content in the current UI test is normal, the test executor 55b then stores “pass” as a value for the output content normality in the test result database 54g for the current UI test (S65).

When determining in S64 that the output content in the current UI test is not normal, the test executor 55b then stores “fail” as a value for the output content normality in the test result database 54g for the current UI test (S66).

After both of the processing of S65 and the processing of S66, the test executor 55b determines whether the required time of the current UI test (hereinafter referred to as “current required time”) is normal based on the required time (hereinafter referred to as “past required time”) of a UI test other than the current UI test that is the same as the current UI test in executed scenario ID out of the test results in the test result database 54g, and the current required time (S67). The test executor 55b compares the current required time to the past required time. The test executor 55b then determines that the current required time is normal when the current required time is not significantly longer than the past required time and determines that the current required time is not normal when the current required time is significantly longer than the past required time. A variety of methods may be used as the method for comparing the current required time to the past required time. For example, the test executor 55b may calculate a regression line of the past required time. In that case, if the distance between the calculated regression line and the current required time is less than or equal to a specific threshold, the test executor 55b determines that the current required time is not significantly longer than the past required time. If the distance between the calculated regression line and the current required time exceeds this threshold, the test executor 55b determines that the current required time is significantly longer than the past required time.

When determining in S67 that the current required time is normal, the test executor 55b then stores “pass” as a value for the required time normality in the test result database 54g for the current UI test (S68), and ends the operations shown in FIG. 9.

When determining in S67 that the current required time is not normal, the test executor 55b then stores “fail” as a value for the required time normality in the test result database 54g for the current UI test (S69), and ends the operations in FIG. 9.

Next, the operations, which the UI test system 50 takes when determining whether to send a message to the monitoring system 40 will be described.

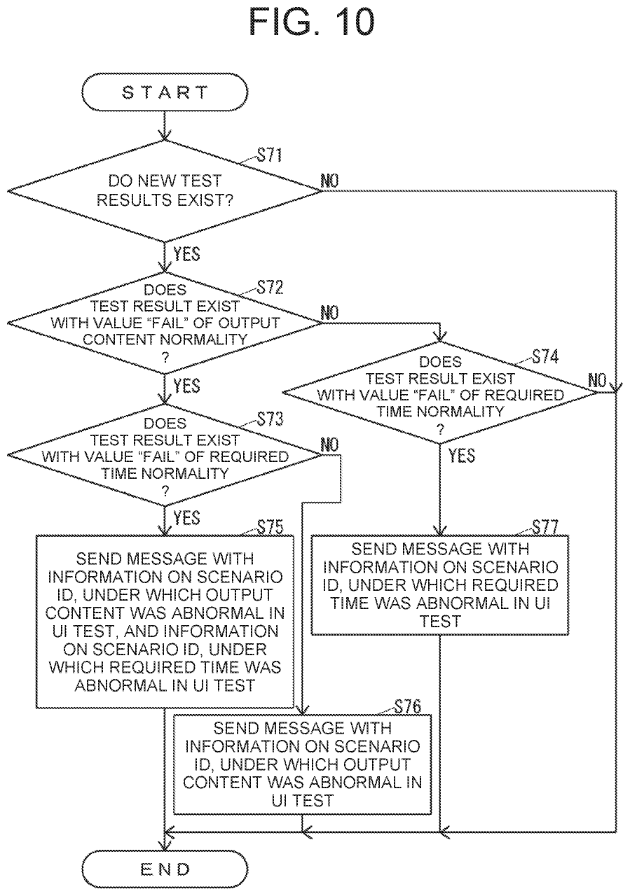

FIG. 10 is a flowchart of the operations, which the UI test system 50 takes when determining whether to send a message to the monitoring system 40.

The controller 55 of the UI test system 50 executes the operations shown in FIG. 10 periodically, for example, every hour.

As shown in FIG. 10, the failure reporter 55c of the UI test system 50 determines whether any test results (hereinafter referred to as “new test results”) exist that have been added to the test result database 54g after the previous start of the operations shown in FIG. 10 and before the current start of the operations shown in FIG. 10 (S71).

When determining in S71 that no new test results exist, the failure reporter 55c ends the operations shown in FIG. 10.

When determining in S71 that new test results exist, the failure reporter 55c then determines whether there is a test result, in which the value of the output content normality is “fail,” among the new test results (S72).

When determining in S72 that there is a test result, in which the value of the output content normality is “fail,” among the new test results, the failure reporter 55c then determines whether there is a test result, in which the value of the required time normality is “fail,” among the new test results (S73).

When determining in S72 that there is no test result, in which the value of the output content normality is “fail,” among the new test results, the failure reporter 55c then determines whether there is a test result, in which the value of the required time normality is “fail,” among the new test results (S74).

When determining in S73 that there is a test result, in which the value of the required time normality is “fail,” among the new test results, the failure reporter 55c then sends, to the monitoring system 40, a message that includes information on the scenario ID, under which the output content was abnormal in the UI test, and information on the scenario ID, under which the required time was abnormal in the UI test (S75). In other words, the message sent to the monitoring system 40 in S75 is for reporting under what scenario ID the result of the UI test was an abnormality in output content, and for reporting under what scenario ID the result of the UI test was an abnormality in required time.

When determining in S73 that there is no test result, in which the value of the required time normality is “fail,” among the new test results, the failure reporter 55c then sends, to the monitoring system 40, a message that includes information on the scenario ID, under which the output content was abnormal in the UI test (S76). In other words, the message sent to the monitoring system 40 in S76 is for reporting under what scenario ID the result of the UI test was an abnormality in output content.

When determining in S74 that there is a test result, in which the value of the required time normality is “fail,” among the new test results, the failure reporter 55c then sends, to the monitoring system 40, a message that includes information on the scenario ID, under which the required time was abnormal in the UI test (S77). In other words, the message sent to the monitoring system 40 in S77 is for reporting under what scenario ID the result of the UI test was an abnormality in required time.

When determining in S74 that there is no test result, in which the value of the required time normality is “fail,” among the new test results, and when executing the processing of any of S75, S76 and S77, the failure reporter 55c ends the operations shown in FIG. 10.

Next, the operations, which the monitoring system 40 takes when having received a message from the UI test system 50, will be described.

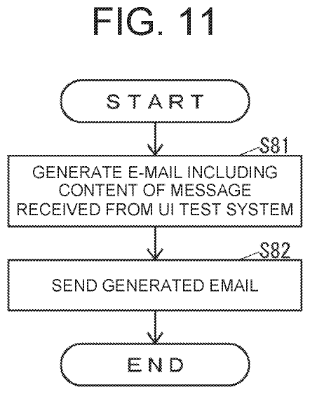

FIG. 11 is a flowchart of the operations, which the monitoring system 40 takes when having received a message from the UI test system 50.

When having received a message from the UI test system 50, the reporter 45b of the monitoring system 40 then executes the operations shown in FIG. 11.

As shown in FIG. 11, the reporter 45b generates an e-mail including the content of the message received from the UI test system 50 (S81).

Next, the reporter 45b sends the e-mail generated in S81 to the contact address contained in the contact address information 44b (S82), then ends the operations shown in FIG. 11.

Therefore, the recipient of the e-mail sent in S82 can start investigating the remote management system 30 based on the content included in the e-mail.

As described above, since the UI test system 50 automatically executes a UI test (S62) and reports a failure in the remote management system 30 depending on the result of the UI test (S75, S76 or S77), a failure in the remote management system 30 can be automatically detected with respect to an operation through the web application of the remote management system 30.

In the UI test system 50, the UI test is for detecting an abnormality in output content in the UI test. Owing to such configuration, the UI test system 50 can automatically detect an abnormality in output content of the remote management system 30 with respect to an operation through the web application of the remote management system 30. Therefore, the UI test system 50 can make the developer of the remote management system 30, for example, aware of whether the remote management system 30 is actually responsive to an operation through the web application of the remote management system 30.

In the UI test system 50, the UI test is also for detecting an abnormality in required time of the UI test. Owing to such configuration, the UI test system 50 can automatically detect an abnormality in time required until the output from the remote management system 30 with respect to an operation through the web application of the remote management system 30. Therefore, the UI test system 50 can make the developer of the remote management system 30, for example, aware of whether the response speed of the remote management system 30 is kept normal with respect to an operation through the web application of the remote management system 30, that is to say, whether the operability through the web application of the remote management system 30 is normal.

The UI of the remote management system 30 in the present embodiment is the web application of the remote management system 30. However, the UI of the remote management system 30 may be a UI of the remote management system 30 other than the web application. For example, the UI of the remote management system 30 may be composed of any software application installed on the remote management system 30, such as an image forming apparatus simulator installed on the remote management system 30 in order to simulate the operations from an image forming apparatus to the remote management system 30.

In the present embodiment, the monitoring system 40 and the UI test system 50 are separate systems, but may also be combined into one system.

What is claimed is:

1. A failure detection system to detect a failure in a system, the failure detection system comprising:
a test executor that automatically executes a test for normality of the system with respect to an operation through a user interface of the system; and
a failure reporter that reports the failure according to a result of the test executed by the test executor.

2. The failure detection system according to claim 1, wherein the test is executed to detect an abnormality in output content in the test.

3. The failure detection system according to claim 1, wherein the test is executed to detect an abnormality in time having been occupied by the test.

4. A non-transitory computer-readable recording medium storing a failure detection program for detecting a failure in a system, the failure detection program causing a computer to implement:
a test executor to automatically execute a test for normality of the system with respect to an operation through a user interface of the system; and
a failure reporter to report the failure according to a result of the test executed by the test executor.
